(19) United States
(12) Patent Application Publication
(10) Pub. No.: US 2017/0001421 A1
(43) Pub. Date: Jan. 5, 2017

(54) CHOPPED STRAND PVC FLOOR AND PRODUCTION METHOD THEREOF

(71) Applicant: Zhejiang Kingdom Plastics Industry Co., Ltd., Tongxiang City (CN)

(72) Inventor: Huibin DAI, Tongxiang City (CN)

(21) Appl. No.: 15/198,206

(22) Filed: Jun. 30, 2016

(30) Foreign Application Priority Data
Jun. 30, 2015 (CN) 201510371626.8

(51) Int. Cl. B32B 27/30; B32B 27/22; B32B 27/06; B29C 65/00; B32B 37/10; B32B 37/18; B29C 65/02; B32B 27/20; B32B 37/06

(52) U.S. Cl. CPC B32B 27/304; B32B 27/20; B32B 27/22; B32B 27/06; B32B 37/06; B32B 37/10; B32B 37/182; B29C 65/02; B29C 66/71; B29C 66/7212; B29C 66/723; B32B 2262/101; B32B 2264/104; B32B 2307/558; B32B 2419/04; B32B 2307/554; B32B 2327/06; B29L 2031/732

(57) ABSTRACT

A chopped strand polyvinyl chloride (PVC) floor sequentially comprises an abrasion-resisting layer, a color film layer, a middle layer, and a base layer. The percentage of PVC in the middle layer is 15%-20% per weight of the middle layer, the percentage of plasticizer in the middle layer is 4%-8% per weight of the middle layer, the percentage of stabilizer in the middle layer is 1%-5% per weight of the middle layer, the percentage of calcium carbonate in the middle layer is 65%-75%, and the percentage of auxiliary materials in the middle layer is 0.5%-3%, and the percentage of chopped strands in the middle layer is 2%-10%.

### CROSS-REFERENCE TO RELATED APPLICATIONS

This Non-provisional application claims priority under 35 U.S.C. §119(a) on Patent Application No(s). 201510371626.8 filed in People's Republic of China on Jun. 30, 2015, the entire contents of which are hereby incorporated by reference.

### BACKGROUND OF THE INVENTION

Field of the Invention

This invention relates to the field of floor production, in particular to a chopped strand polyvinyl chloride (PVC) floor having good dimensional stability and a production method thereof.

Description of the Related Art

PVC floors have been generally applied in daily life. However, conventional polyvinyl chloride (PVC) floors have a high contraction rate and a high expansion rate. During the use process, the product dimensions change greatly, and gaps are easily produced in the PVC floors or the PVC floors mutually extrude to produce deformation or even breakage and other irreversible damages due to heat expansion and cold contraction. Moreover, the conventional PVC floors are higher in hardness and often cause edge cracking during punching and cutting. Thus, the normal use of the PVC floors is affected, and the service life of the PVC floors is shortened.

### BRIEF SUMMARY OF THE INVENTION

In order to solve the existing problems, this invention provides a chopped strand polyvinyl chloride (PVC) floor having good dimension stability and impact resistance and a production method thereof.

To achieve the above-mentioned objective, this invention provides a chopped strand PVC floor sequentially comprising an abrasion-resisting layer, a color film layer, a middle layer, and a base layer. The percentage of PVC in the middle layer is 15%-20% per weight of the middle layer, the percentage of plasticizer in the middle layer is 4%-8% per weight of the middle layer, the percentage of stabilizer in the middle layer is 1%-5% per weight of the middle layer, the percentage of calcium carbonate in the middle layer is 65%-75%, and the percentage of auxiliary materials in the middle layer is 0.5%-3%, and the percentage of chopped strands in the middle layer is 2%-10%.

According to one embodiment of the invention, the middle layer may include, per weight, PVC 15%, plasticizer 6%, stabilizer 2%, calcium carbonate 71%, auxiliary materials 1%, and chopped strands 5%.

According to one embodiment of the invention, the auxiliary materials may include chlorinated polyethylene.

According to one embodiment of the invention, the middle layer may include a first middle layer and a second middle layer, wherein the first middle layer and the second middle layer are tightly laminated.

According to one embodiment of the invention, the chopped strands may be glass fibers, and a length of the glass fibers is 2 mm-10 mm.

According to one embodiment of the invention, a particle size of the calcium carbonate is 80-120 meshes.

According to one embodiment of the invention, a thickness ratio of the first middle layer to the second middle layer to the base layer is 1:(0.5-1):(0.5-1).

The invention further provides a production method for producing the chopped strand PVC floor comprising the following steps:

a. raising temperature of a heating furnace to the range of 170° C. to 185° C., then putting auxiliary materials and chopped strands mixed with each other evenly into the heating furnace and maintaining heating for 10 to 15 minutes;

b. evenly mixing PVC, plasticizer, stabilizer, calcium carbonate to form a mixture and putting the mixture into an internal mixer to internal mixing;

c. adding the auxiliary materials and the chopped strands heat treated in step a to internal mixer for continuous internal mixing and obtaining a middle layer;

d. conducting open mixing on the middle layer obtained in step c in an open mixing machine; and

e. hot pressing the middle layer obtained in step d with the abrasion-resisting layer, the color film layer, and the base material layer.

According to one embodiment of the invention, the hot pressing step comprises:

stacking a first middle layer on a second middle layer, and performing pre-lamination through heating and pressurizing to obtain the middle layer;

sequentially placing the abrasion-resisting layer, the color film layer, the middle layer, and the base layer properly and then performing hot-press lamination; and

naturally cooling in the air after hot-press lamination.

According to one embodiment of the invention, the internal mixing temperature may be 175° C. to 195° C., the internal mixing time in steps b and c may be 2 to 8 minutes, wherein the internal mixing time in step c may be longer than or equal to the internal mixing time in step b.

According to one embodiment of the invention, the open mixing temperature may be 135° C. to 170° C.

The chopped strand PVC floor has the advantages as follows:

The Shore Hardness of the conventional middle layer is 65-68°, while the Shore Hardness of the middle layer in this invention is 55-57°. The hardness of the middle layer is remarkably reduced by using the chopped strands, the overall hardness of products can be reduced, the impact resistance of the product is improved, and the strength of the product is improved. In addition, the weather resistance and flexibility of the product are improved by adding the chlorinated polyethylene, and edge cracking during punching and cutting due to temperature change is effectively prevented.

The chlorinated polyethylene and the chopped strands are subjected to preheating treatment in the heating furnace to change their interface performance so that the chlorinated polyethylene and the chopped strands can produce better compatibility and tensile properties when being internally mixed with other raw materials. Thus, the contraction rate and expansion rate of the products are effectively reduced, and the dimensional stability of the products is improved.

Grid glass fibers are not needed between the first middle layer and the second middle layer, since the middle layer added with the chopped strands is subjected to hot pressing. Thus, the fitting firmness will not be affected under the situations, such as inappropriate grid size and improper operation, during usage of grid glass fibers, and the contraction rate and expansion rate of the product are also prevented from increasing. The production process is optimized.

These and other features, aspects, and advantages of the present invention will become better understood with regard to the following description, appended claims, and accompanying drawings.

### DETAILED DESCRIPTION OF THE INVENTION

### Embodiment 1

This embodiment relates to a chopped strand polyvinyl chloride (PVC) floor, which sequentially comprises an abrasion-resisting layer, a color film layer, a first middle layer, a second middle layer, and a base layer from top to bottom. The raw material components included in the first middle layer and the second middle layer are the same and include PVC, plasticizer, stabilizer, calcium carbonate, chlorinated polyethylene, and chopped strands. In this embodiment, the chopped strands are glass fibers, and the length of the glass fibers is 3 mm to 6 mm. The particle size of the calcium carbonate is 100 meshes.

The production process of the chopped strand PVC floor comprises the following steps:

raising the temperature of the heating furnace to the range of 170° C. to 185° C., then putting 1% chlorinated polyethylene per weight and 5% glass fibers per weight which are mixed evenly with each other into the heating furnace, and continuing to heat for 10 to 15 minutes;

then evenly mixing PVC 15%, plasticizer 6%, stabilizer 2% and calcium carbonate 71% per weight to form a mixture, putting the mixture into an internal mixing machine to perform internal mixing at the temperature of 175° C. to 195° C. for three minutes, and then putting the chlorinated polyethylene and the chopped strands which are subjected to heating and heat preservation in the internal mixing machine immediately to continuously perform internal mixing for 6 minutes; conducting open mixing on the semi-finished product obtained after the internal mixing is completed at the temperature of 150° C. to 170° C. to obtain the second middle layer, and pressing the semi-finished product obtained after the internal mixing is completed to form the first middle layer.

finally, pre-laminating the obtained first middle layer and the obtained second middle layer, then sequentially laying the abrasion-resisting layer, the color film layer, the middle layer and the base layer properly, conducting hot-press lamination, and then naturally cooling.

The parameters of the chopped strand PVC floor are as follows: the thickness ratio of the first middle layer to the second middle layer to the base layer is 1:1:0.6, the first middle layer is 1.8 mm; the tested contraction rate of the product is 0.04% after the product is heated for six hours at the temperature of 80° C.; the tested expansion rate of the product in a 50° C. environment is 0.055% after the product is heated for two hours at the temperature of 50° C. The contraction rate of the existing product after being heated for six hours at the temperature of 80° C. is 0.10%-0.15%, and the expansion rate of the existing product after being heated for two hours at the temperature of 50° C. is 0.085%-0.197%. Therefore, the contraction rate and the expansion rate are greatly reduced. The Shore Hardness of the middle layer in this invention is 55°.

### Embodiment 2

This embodiment relates to a chopped strand PVC floor, which sequentially comprises an abrasion-resisting layer, a color film layer, a first middle layer, a second middle layer, and a base layer from top to bottom, wherein the raw material components included in the first middle layer and the second middle layer are the same and include PVC, plasticizer, stabilizer, calcium carbonate, chlorinated polyethylene, and chopped strands. In this embodiment, the chopped strands are glass fibers, and the length of the glass fibers is 4 to 5 mm. The particle size of the calcium carbonate is 80 meshes.

The production process of the chopped strand PVC floor comprises the following steps:

raising the temperature of the heating furnace to the range of 170° C. to 185° C., then putting 1% chlorinated polyethylene per weight and 7% glass fibers per weight which are mixed evenly with each other in the heating furnace, and continuing to heat for 10 to 15 minutes; then evenly mixing PVC 18%, plasticizer 4%, stabilizer 2% and calcium carbonate 68%, putting the mixture in an internal mixing machine to perform internal mixing at the temperature of 185° C. to 195° C. for 4 minutes, and then putting the chlorinated polyethylene and the chopped strands which are subjected to heating and heat preservation in the internal mixing machine immediately to continuously perform internal mixing for 5 minutes; conducting open mixing on the semi-finished product obtained after the internal mixing is completed at the temperature of 150° C. to 160° C. to obtain the second middle layer, and pressing the semi-finished product obtained after the internal mixing is completed to form the first middle layer;

finally, pre-laminating the obtained first middle layer and the obtained second middle layer, then sequentially laying the abrasion-resisting layer, the color film layer, the middle layer and the base layer properly, conducting hot-press lamination, and then naturally cooling.

The parameters of the chopped strand PVC floor are as follows: the thickness ratio of the first middle layer to the second middle layer to the base layer is 1:0.6:0.8, the first middle layer is 2 mm; the tested contraction rate of the product is 0.04% after the product is heated for six hours at the temperature of 80° C.; the tested expansion rate of the product in a 50 V environment is 0.058% after the product is heated for two hours at the temperature of 50° C. The Shore Hardness of the middle layer in this invention is 56°.

### Embodiment 3

The chopped strand PVC floor in this embodiment sequentially comprises an abrasion-resisting layer, a color film layer, a middle layer and a base layer from top to bottom, and the middle layer comprises, percentage per weight, PVC 20%, plasticizer 7%, stabilizer 4%, calcium carbonate 75% and glass fibers 10%, wherein the length of the glass fibers is 6 to 10 mm, and the particle size of the calcium carbonate is 120 meshes.

The production process comprises the steps:

raising the temperature of the heating furnace to 170° C. to 185° C., then quickly putting the glass fibers and the chopped strands which are mixed evenly in the heating furnace, and continuing to heat for 10 to 15 minutes; then evenly mixing the PVC, the plasticizer, the stabilizer and the calcium carbonate, putting the mixture in an internal mixing machine to perform internal mixing at the temperature of 185° C. to 195° C. for 6 minutes, and then putting the glass fibers and the chopped strands which are subjected to heat treatment in the internal mixing machine to continuously perform internal mixing for 6 minutes so as to obtain the middle layer; conducting open mixing on the obtained middle layer at the temperature of 140° C. to 160° C. to obtain the second middle layer, and pressing another obtained second middle layer to form the first middle layer;

finally, pre-laminating the obtained first middle layer and the obtained second middle layer, then sequentially laying the abrasion-resisting layer, the color film layer, the middle layer and the base layer properly, conducting hot-press lamination, and then naturally cooling. The Shore Hardness of the middle layer in this invention is 57°.

The parameters of the chopped strand PVC floor are as follows: the thickness ratio of the first middle layer to the second middle layer to the base layer is 1:0.5:1, the first middle layer is 1.6 mm; the tested contraction rate of the product is 0.05% after the product is heated for six hours at the temperature of 80° C.; the tested expansion rate of the product is 0.064% in a 50° C. environment after the product is heated for two hours at the temperature of 50° C.

### Embodiment 4

The chopped strand PVC floor sequentially in this embodiment comprises an abrasion-resisting layer, a color film layer, a middle layer and a base layer from top to bottom, and the middle layer comprises, by weight, PVC 20%, plasticizer 4%, stabilizer 1%, calcium carbonate 75% and glass fibers 1%, wherein the length of the glass fibers is 2 to 5 mm, and the particle size of the calcium carbonate is 100 meshes.

The production process comprises the steps: raising the temperature of the heating furnace to 170° C. to 185° C., then quickly putting the glass fibers and the chopped strands which are mixed evenly in the heating furnace, and continuing to heat for 10 to 15 minutes; then evenly mixing the PVC, the plasticizer, the stabilizer and the calcium carbonate, putting the mixture in the internal mixing machine to perform internal mixing at the temperature of 180° C. to 185° C. for 3 minutes, and then putting the glass fibers and the chopped strands which are subjected to heat treatment in an internal mixing machine to continuously perform internal mixing for 8 minutes so as to obtain the middle layer; conducting open mixing on the obtained middle layer at the temperature of 140° C. to 160° C.;

finally, sequentially laying the abrasion-resisting layer, the color film layer, the middle layer and the base layer properly, conducting hot-press lamination, and then naturally cooling.

The parameters of the chopped strand PVC floor are as follows: the thickness ratio of the middle layer to the base layer is 1:0.5, the middle layer is 2.5 mm; the tested contraction rate of the product is 0.47% after the product is heated for six hours at the temperature of 80° C.; the tested expansion rate of the product is 0.076% in a 50° C. environment after the product is heated for two hours at the temperature of 50° C. The Shore Hardness of the middle layer in this invention is 55°.

According to an existing production process, a piece of grid glass fibers is needed to be added between the first middle layer and the second middle layer during film spreading, overly small grids of the grid glass fibers block the fitting force of a layer material between the upper layer and the lower layer, and the whole fitting strength of the product is affected; overly large grids of the grid glass fibers cause poor vertically and horizontally knitting firmness among the glass fibers and likely tear; when the grid glass fibers are overlaid during film spreading, creases are easily produced due to improper operation, and the defective rate of the product is increased.

The usage of the grid glass fibers during conventional hot pressing aims at controlling the contraction rate and expansion rate of the product, but a good desired effect cannot be achieved only through the grid glass fibers, and the overall contraction rate and expansion rate of the product is still higher; the contraction rate and expansion rate of the chopped strand PVC floor prepared by adopting the production process of the invention can be controlled to vary low values, the dimension of the product is relatively stable during contraction and expansion. In addition, the chopped strand PVC floor is low in overall hardness, the toughness is enhanced, and the phenomenon that the edges of the products crack during punching is effectively prevented.

The specific embodiments are only used for describing the invention, rather than for limiting the invention. Within the purpose and protective scope of the claims of the invention, the replacements and modifications on the invention without creative labor fall into the protective scope of the invention.

What is claimed is:

1. A chopped strand polyvinyl chloride (PVC) floor sequentially comprises an abrasion-resisting layer, a color film layer, a middle layer, and a base layer, wherein the percentage of PVC in the middle layer is 15%-20% per weight of the middle layer, the percentage of plasticizer in the middle layer is 4%-8% per weight of the middle layer, the percentage of stabilizer in the middle layer is 1%-5% per weight of the middle layer, the percentage of calcium carbonate in the middle layer is 65%-75%, and the percentage of auxiliary materials in the middle layer is 0.5%-3%, and the percentage of chopped strands in the middle layer is 2%-10%.

2. The chopped strand polyvinyl chloride floor according to claim 1, wherein the middle layer comprises, per weight, PVC 15%, plasticizer 6%, stabilizer 2%, calcium carbonate 71%, auxiliary materials 1%, and chopped strands 5%.

3. The chopped strand polyvinyl chloride floor according to claim 1, wherein the auxiliary materials include chlorinated polyethylene.

4. The chopped strand polyvinyl chloride floor according to claim 1, wherein the middle layer includes a first middle layer and a second middle layer, and the first middle layer and the second middle layer are tightly laminated.

5. The chopped strand polyvinyl chloride floor according to claim 1, wherein the chopped strands are glass fibers, and a length of the glass fibers is 2 mm-10 mm.

6. The chopped strand polyvinyl chloride floor according to claim 1, wherein a particle size of the calcium carbonate is 80-120 meshes.

7. A production method for producing the chopped strand PVC floor as claimed in claim 1 comprising the following steps:
a. raising temperature of a heating furnace to the range of 170° C. to 185° C., then putting auxiliary materials and chopped strands mixed with each other evenly into the heating furnace and maintaining heating for 10 to 15 minutes;
b. evenly mixing PVC, plasticizer, stabilizer, calcium carbonate to form a mixture and putting the mixture into an internal mixer to internal mixing;
c. adding the auxiliary materials and the chopped strands heat treated in step a to internal mixer for continuous internal mixing and obtaining a middle layer;
d. conducting open mixing on the middle layer obtained in step c in an open mixing machine; and
e. hot pressing the middle layer obtained in step d with the abrasion-resisting layer, the color film layer, and the base material layer.

8. The production method according to claim 7, wherein the hot pressing step comprises:
stacking a first middle layer on a second middle layer, and performing pre-lamination through heating and pressurizing to obtain the middle layer;
sequentially placing the abrasion-resisting layer, the color film layer, the middle layer, and the base layer properly and then performing hot-press lamination; and
naturally cooling in the air after hot-press lamination.

9. The production method according to claim 7, wherein the internal mixing temperature is 175° C. to 195° C., the internal mixing time in steps b and c is 2 to 8 minutes, and the internal mixing time in step c is longer than or equal to the internal mixing time in step b.

10. The production method according to claim 7, wherein the open mixing temperature is 135° C. to 170° C.
